(19) United States
(12) Patent Application Publication
(10) Pub. No.: US 2018/0285447 A1
(43) Pub. Date: Oct. 4, 2018

(54) CONTENT RECOMMENDATION APPARATUS, CONTENT RECOMMENDATION SYSTEM, CONTENT RECOMMENDATION METHOD, AND PROGRAM

(71) Applicant: NEC Personal Computers, Ltd., Tokyo (JP)

(72) Inventor: Tsuyoshi Takemoto, Tokyo (JP)

(73) Assignee: NEC Personal Computers, Ltd., Tokyo (JP)

(21) Appl. No.: 15/476,127

(22) Filed: Mar. 31, 2017

(51) Int. Cl. G06F 17/30

(52) U.S. Cl. CPC G06F 17/30675; G06F 17/30011; G06F 17/30707

(57) ABSTRACT

The present invention recommends information desired by a user. A content recommendation apparatus of the present invention identifies a category of a document acquired via a network and/or a term included in the document based on a first database, extracts, as a search keyword, a term associated with the category of the document and/or the term identified, searches for a content using the extracted search keyword, classifies a term included in a document in the retrieved content based on the appearance frequency, determines a feature value of a term in the category of the term classified, determines a degree of interest in each classified term based on a second database, and identifies, from retrieved contents, a recommended content based on the feature value and/or the degree of interest.

### FIELD OF THE INVENTION

The present invention relates to a content recommendation apparatus, a content recommendation system, a content recommendation method, and a program.

### BACKGROUND OF THE INVENTION

Recently, enormous amounts of information and data have been provided from the Internet and broadcast networks, and the kinds of provided information have also been diversified. Further, the number of users to acquire information from the Internet and broadcast networks has increased. In such a situation, there is already known a system in which a provider providing contents using the Internet or broadcast networks collects the history of each user to access the Internet and the like, analyzes a taste of each user based on the collected access history, and recommends a content that matches the analyzed taste.

A technique associated with the content recommendation system mentioned above is disclosed, for example, in Patent Document 1. Patent Document 1 discloses a technique for preparing a table, in which history information and user-specific information are associated with each other to be able to follow changes in user's taste, to reflect user history information in the table in order to provide information beneficial to the user.

[Patent Document 1] Japanese Patent Application Publication No. 2009-087155

### SUMMARY OF THE INVENTION

However, for example, since the conventional technique disclosed in Patent Document 1 is basically to identify a recommended content based on the acquired history information, the recommended content necessarily becomes stereotyped, which may not be information desired by the user. This problem has become notable in recent years as enormous amounts of information and data provided from the Internet and broadcast networks have increased more and more. This leads to making the user feel frustrated or stressed about the fact that a recommended content is different from that intended by the user.

present invention has been made in view of such circumstances, and it is an object thereof to provide a system capable of recommending information desired by each user.

In order to solve the above problem, a content recommendation apparatus of the present invention includes: a first database in which documents are systematized for each of categories including the documents and for each of terms included in the documents; a second database in which degrees of user's interest in predetermined terms are systematized; an identification section which identifies a category of a document acquired via a network and/or a term included in the document based on the first database; a search keyword extracting section which extracts, as a search keyword, a term associated with the category of the document and/or the term identified by the identification section; a content searching section which searches for a content using the search keyword extracted by the search keyword extracting section; a classification section which classifies a term included in a document in the content retrieved by the content searching section based on an appearance frequency; a feature value determining section which determines a feature value of a term in a category of the term classified by the classification section; a degree-of-interest determining section which determines a degree of interest in each term classified by the classification section based on the second database; and a recommended content identifying section which identifies, from contents retrieved by the content searching section, a recommended content based on the feature value and/or the degree of interest.

According to the present invention, information desired by a user can be recommended.

### BRIEF DESCRIPTION OF THE DRAWINGS

FIG. 1 is a configuration diagram of a system including a content recommendation apparatus in an embodiment of the present invention.

FIG. 2 is a hardware configuration diagram of the content recommendation apparatus in the embodiment of the present invention.

FIG. 3 is a functional block diagram of the content recommendation apparatus in the embodiment of the present invention.

FIG. 4 is a schematic chart for describing recommended content identification processing in the embodiment of the present invention.

FIG. 5 is a flowchart illustrating a content recommendation procedure in the embodiment of the present invention.

### DETAILED DESCRIPTION OF THE INVENTION

A content recommendation apparatus of an embodiment of the present invention will be described with reference to the accompanying drawings. Note that the same or corresponding parts in respective drawings are given the same reference numerals to appropriately simplify or omit the redundant description thereof. Further, the embodiment to be described below is the best form of the present invention, but not to limit the scope of claims according to the present invention.

The term “content” in the embodiment means a set of pieces of information, such as video, music, text, or a combination thereof, recorded on media or transmitted to be appreciated by people, in addition to the ordinary meaning of the word “content.” In an actual case, for example, the content means an application delivered via the Internet, a downloadable video content or a music content, or the like.

<System Configuration Including Content Recommendation Apparatus in an Embodiment>

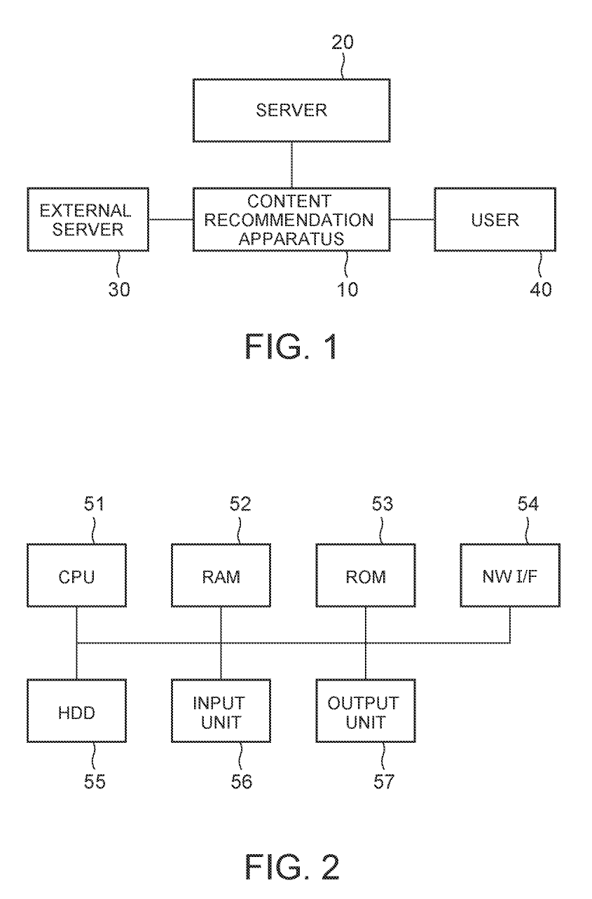

A system configuration including the content recommendation apparatus in an embodiment will be described with reference to FIG. 1. The system configuration of the embodiment is such that a content recommendation apparatus 10 which recommends a content and a server 20 are connected through a network. The form of the network may be a LAN or a WAN, and the network may be such a form to establish a wired connection or a wireless connection.

The content recommendation apparatus 10 is an information processing apparatus such as a PC capable of executing each process according to the embodiment to be described later. The server 20 may be a home server connected to the LAN or an external server connected to the WAN. Note that the term “server” is used as a generic name of hardware to implement a server in the embodiment. The server 20 may be, for example, a PC, a storage, or a dedicated server machine.

In the embodiment, a system configuration in which the server 20 is connected externally to the content recommendation apparatus 10 will be described, but the system configuration may be such that the content recommendation apparatus 10 has a server function. Note that it is preferred that the server 20 should acquire information and data from the outside through the network periodically and accumulate the acquired information and data as a database in a predetermined format. The details of the database stored in the server 20 will be described later.

The content recommendation apparatus 10 analyzes a degree of interest of a user 40 and the like based on information and data on multiple contents acquired from an external server 30 and stored in the server 20 to recommend the best content to the user 40. The external server 30 is, for example, a web server connected via the Internet or the like, and a content provided from the external server 30 may be provided in the form of an application, as image data, in the form of video or sound, or in the form of a combination thereof.

<Hardware Configuration of Content Recommendation Apparatus in an Embodiment>

Referring next to FIG. 2, a hardware configuration of the content recommendation apparatus 10 in an embodiment will be described. The content recommendation apparatus 10 includes, as the hardware configuration, a CPU 51, a RAM 52, a ROM 53, an NW I/F 54, an HDD 55, an input unit 56, and an output unit 57. Note that these components are to illustrate an example of such a configuration that the content recommendation apparatus 10 executes functions (processes) to be described later, and the embodiment is not to exclude any hardware component other than these components. Further, all of these components are not necessarily included. For example, the HDD 55 is not an indispensable component.

The CPU 51 is a main control unit which executes each process to be described later on the content recommendation apparatus 10. The CPU 51 implements each function of the content recommendation apparatus 10 by executing a processing program defining each process stored in the ROM 53 and read into the RAM 52.

The RAM 52 is a storage unit functioning as a work memory of the CPU 51 as mentioned above. The ROM 53 is a storage unit to store the processing program that defines each process as mentioned above, and other various parameters and the like required to control the content recommendation apparatus 10.

The NW I/F 54 is a network interface to connect to the external server 30 illustrated in FIG. 1. The HDD 55 is a mass-storage unit to store contents.

The input unit 56 includes input devices such as a keyboard and a mouse. The input unit 56 may also include a device which accepts a user touch operation, such as a touch panel superimposed on a display unit to be described later. Further, a camera which takes a picture to acquire an image, and a microphone which accepts voice input may be included in the input unit 56.

The output unit 57 is a display unit such as a display. The output unit 57 may also include a speaker to output sound.

<Functional Blocks of Content Recommendation Apparatus in an Embodiment>

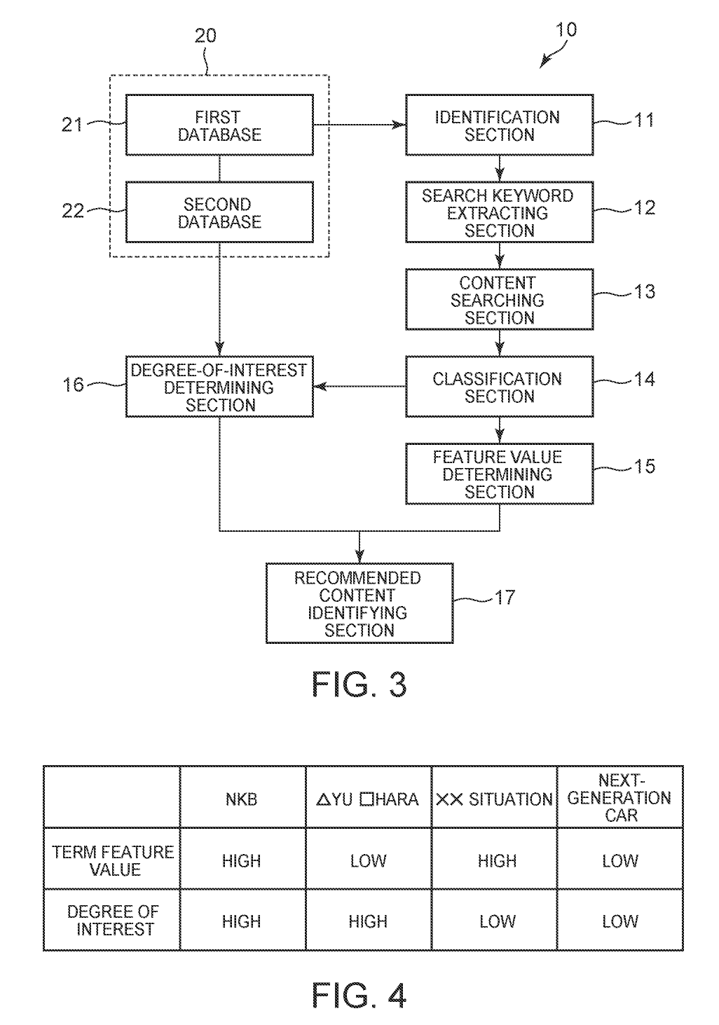

Referring next to FIG. 3, functional blocks of the content recommendation apparatus 10 in an embodiment will be described. The content recommendation apparatus 10 includes a first database 21, a second database 22, an identification section 11, a search keyword extracting section 12, a content searching section 13, a classification section 14, a feature value determining section 15, a degree-of-interest determining section 16, and a recommended content identifying section 17.

The first database 21 is a database in which documents are systematized for each of categories including the documents and/or for each of terms included in the documents. In the embodiment, the “document” means document data and the like that constitute a website, for example. Further, in the embodiment, the “term” means a word appearing in the documents, and the first database 21 extracts the word from the documents, for example, by morphological analysis or the like.

The second database 22 is a database in which degrees of user's interest in a predetermined term are systematized. Each degree of interest in the predetermined term may be a point or the like given to be able to determine the high/low level of the degree of interest based, for example, on a content viewing history including the predetermined term, the history of specific operations by the user to viewed contents, or the like. Note that “first” and “second” are attached to these databases for the sake of convenience, i.e., to make these databases distinguishable, rather than to define relative merits or ordering as indicating which one has an advantage over the other.

The identification section 11 is a section which identifies the category of a document acquired via the network, and a term included in the document based on the first database mentioned above. Here, the “acquired document” means document data and the like included in a content viewed through the network. Note that identifying a term means identifying the appearance frequency of the term, a degree of general attention to the term, or the like. In other words, the first database 21 stores information on each individual term to feature the term together with the term. This can lead to identifying the category of the acquired document and identifying the details of the term included in the acquired document.

The search keyword extracting section 12 is a section which extracts, as a search keyword, a term associated with the category of the document and/or the term identified by the identification section 11. Since the term associated with the category of the document and/or the identified term is used as the search keyword to make a search so that information associated with the acquired document can be retrieved.

The content searching section 13 is a section which searches for a content on a predetermined content server using the search keyword extracted by the search keyword extracting section 12. Note that when two or more search keywords are extracted by the search keyword extracting section 12, the content searching section 13 may perform search processing on one of the two or more search keywords at a time, or perform AND search or OR search using the two or more search keywords.

The classification section 14 is a section which classifies a term included in a document in the content retrieved by the content searching section 13 based on the appearance frequency. As the classification method, for example, terms may be ranked from the highest appearance frequency, terms similar in appearance frequency may be classified together, or the terms may be classified by any other predetermined rule. Such a classification enables the appearance tendency of each term in the retrieved content to be grasped. As the method of extracting the term from the document, for example, morphological analysis or the like can be performed as described above.

The feature value determining section 15 is a section which determines the feature value of a term in the category of the term classified by the classification section 14. The feature value of the term in the category can be calculated by dividing the appearance frequency (denoted by “P1”) of the term in a specific category of the term by a value obtained by multiplying the appearance frequency (denoted by “P2”) of the total term group included in the specific category by the appearance frequency (denoted by “P3”) of the term included in all categories (i.e. “P1/(P2×P3)” as the mathematical expression). Thus, a degree of general attention to a specific term can be determined. In other words, it is found that a term high in feature value in a category is high in degree of general attention, while a term low in feature value in the category is low in degree of general attention. Even when many common words, such as postpositional particles and dates and times, which do not feature the category but appear frequently, are included, an appropriate term can be selected as a determination target by the above calculation with no effect of these words.

The degree-of-interest determining section 16 is a section which determines a degree of interest in each of terms classified by the classification section 14 based on the second database 22. When the degree of interest in a classified term is high, there is a high possibility that a content including the term will be information in which the user is interested.

The recommended content identifying section 17 is a section which identifies, from contents retrieved by the content searching section 13, a recommended content based on the feature value in the category and the degree of interest as mentioned above. When the feature value of a term in the category of the term included in a content (document) is high and the degree of interest in the term is high, the content including the term is information desired by the user, and hence the recommendation of such a content is beneficial to the user. The detailed contents of processing by the recommended content identifying section 17 will be described below.

<Recommended Content Identification Processing in an Embodiment>

Referring next to FIG. 4, recommended content identification processing in an embodiment will be described. In FIG. 4, “Term Feature Value” and “Degree of Interest” are taken on the ordinate, and “NKB” as an example of the name of a pop idol group, “Δyu □hara” as an example of the name of a pop idol, “xx situation” as an example of a specific news category, and “Next-generation car” as an example of a specific topic are taken on the abscissa as categories. Note that these categories are nothing but examples. The feature value of a term means the feature value of the term in each of the above categories, and the degree of interest means a degree of personal interest in the term.

Then, the recommended content identifying section 17 identifies, as a recommended content, a content including “NKB” determined by the feature value determining section 15 to be high in feature value and determined by the degree-of-interest determining section 16 to be high in degree of interest. This can lead to recommending information most desired by the user.

The recommended content identifying section 17 may also identify, as a recommended content, a content including “Δyu □hara” determined by the feature value determining section 15 to be low in feature value but determined by the degree-of-interest determining section 16 to be high in degree of interest. If a content high in degree of interest is recommend even when the feature value is low, the content will be beneficial to the user.

Further, the recommended content identifying section 17 may identify, as a recommended content, a content including “xx situation” determined by the feature value determining section 15 to be high in term feature value but determined by the degree-of-interest determining section 16 to be low in degree of interest. If a content high in feature value even in a category low in degree of interest is not recommended, this may be detrimental to the user. Therefore, the recommendation of such a content is also beneficial to the user.

Further, the recommended content identifying section 17 may identify, as a recommended content, a content including “Next-generation car” determined by the feature value determining section 15 to be low in feature value and determined by the degree-of-interest determining section 16 to be low in degree of interest. Such a content is likely to be information undesired by the user. However, even such a content may be information unknown to the user because the user has not been completely unconcerned with the information so far. Therefore, even such a content may be beneficial to the user in some cases. Specifically, for example, it is the case of a content including a newsworthy topic term such as “Next-generation car” mentioned above.

Note that the recommended content identifying section 17 may also identify recommended contents in order from the most recent one among contents retrieved by the content searching section 13. This can lead to recommending a content with topical information preferentially. It is identified whether the content is the most recent content, that is, topical information, based on search results when the content searching section 13 uses a search keyword to make a search on a predetermined content server. For example, it may be identified whether the content is topical information based on temporal information added to the content, such as the time stamp on a file, information on the delivery date, or the server registration date. It may also be identified whether the content is topical information based on the search ranking of the content server. For example, the ranking may be a ranking in the order of date, an access ranking, or a ranking based on the sales figures or the like. It can also be identified whether the content is topical information based on the timely degree of popularity or attention, rather than the temporal information.

Further, the recommended content identifying section 17 may identify, as a recommended content, a content high in degree of similarity to an acquired document among contents retrieved by the content searching section 13. The degree of similarity between a retrieved content and the acquired document can be determined based on whether a term included in the acquired document is included in the content by a fixed number or more, whether the category of the retrieved content and the category of the acquired document match each other or are associated with each other, or the like. To be more specific, for example, the degree of similarity can be determined based on the calculation result obtained by calculating the degree of similarity between the search keyword identified from the document and the content. The categories associated with each other are, for example, “Economics” and “Finance,” “Automobile” and “High oil prices,” and so on. For example, the category of the retrieved content may be determined by something included in the content as data, or determined by the appearance frequency or the like of a specific term included in a content retrieved on the side of the content recommendation apparatus 10. As for the association between the categories, for example, a method may be used, which groups categories estimated to be associated with each other in advance to determine the association based on information in each group.

<Content Recommendation Procedure in an Embodiment>

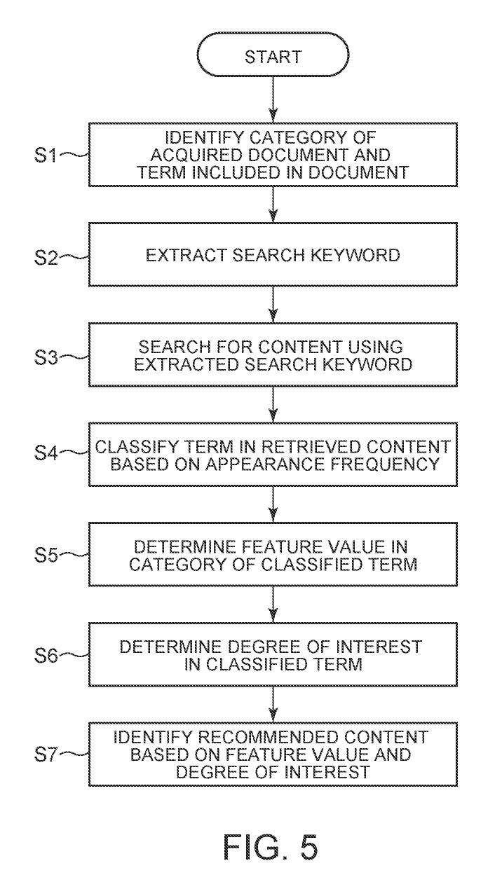

A content recommendation procedure in an embodiment will be described with reference to FIG. 5. First, the identification section 11 identifies the category of an acquired document and a term included in the document (step S1).

Next, the search keyword extracting section 12 extracts, as a search keyword, a term associated with the category and/or the term identified by the identification section 11 (step S2).

Then, the content searching section 13 searches for a content using the search keyword extracted by the search keyword extracting section 12 (step S3).

Subsequently, the classification section 14 classifies respective terms included in a document(s) in the retrieved content based on the appearance frequencies of the terms, respectively (step S4).

The feature value determining section 15 determines the feature value of each of the classified terms in the category of the term (step S5).

Further, based on the second database 22, the degree-of-interest determining section 16 determines the degree of interest of each of the classified terms (step S6).

Then, based on the feature value determined by the feature value determining section 15 and the degree of interest determined by the degree-of-interest determining section 16, the recommended content identifying section 17 identifies a recommended content (step S7).

Note that the aforementioned embodiment is a preferred embodiment of the present invention, and various changes are possible within the gist of the present invention. For example, the content recommendation apparatus of the aforementioned embodiment, or each process in the system including the content recommendation apparatus can be implemented in hardware, software, or a combination of both.

When each process is executed using software, a program with a process sequence recorded therein can be installed in a memory inside a computer incorporated in dedicated hardware, and executed. Alternatively, a program can be installed and executed on a general-purpose computer capable of executing various processes.

In the aforementioned embodiment, the description has been made by focusing on the form of acquiring a content from the external server 30 through the network such as the Internet, but the present invention can also be applied to systems mentioned below. For example, the present invention can be applied to a system composed of a digital TV set owned by a user, and a digital broadcast terminal connected to the digital TV set. In other words, when the user is watching a TV program, a term in data delivered together with broadcast waves of the TV program may be analyzed to recommend another program based on the feature value of the term and the degree of user's interest in the term. Further, the present invention can be applied to a usage scene to link to the Internet or the like in order to recommend a product or the like associated with a term included in a TV program.

Further, for example, users may have terminals capable of performing near field communication (NFC) or the like to allow the content recommendation apparatus 10 to recommend a content to a specific user authenticated through the near field communication. This can lead to recommending a content more specific to the degree of personal interest.

We claim:

1. A content recommendation apparatus comprising:
a first database in which documents are systematized for each category including the documents and for each term included in the documents;
a second database in which degrees of a user's interest in predetermined terms are systematized;
an identification section which identifies a category of a document acquired via a network and/or a term included in the document based on the first database;
a search keyword extracting section which extracts, as a search keyword, a term associated with the category of the document and/or the term identified by the identification section;
a content searching section which searches for content using the search keyword extracted by the search keyword extracting section;
a classification section which classifies a term included in a document in the content retrieved by the content searching section based on an appearance frequency;
a feature value determining section which determines a feature value of a term in a category of the term classified by the classification section;
a degree-of-interest determining section which determines a degree of interest in each term classified by the classification section based on the second database; and
a recommended content identifying section which identifies, from contents retrieved by the content searching section, a recommended content based on the feature value and/or the degree of interest.

2. The content recommendation apparatus according to claim 1, wherein the recommended content identifying section identifies, as the recommended content, a content including a term determined by the feature value determining section to be high in feature value and determined by the degree-of-interest determining section to be high in degree of interest.

3. The content recommendation apparatus according to claim 1, wherein the recommended content identifying section identifies, as the recommended content, a content including a term determined by the feature value determining section low in feature value but determined by the degree-of-interest determining section to be high in degree of interest.

4. The content recommendation apparatus according to claim 1, wherein the recommended content identifying section identifies, as the recommended content, a content including a term determined by the feature value determining section to be high in feature value but determined by the degree-of-interest determining section to be low in degree of interest.

5. The content recommendation apparatus according to claim 1, wherein the recommended content identifying section identifies, as the recommended content, a content including a term determined by the feature value determining section to be low in feature value and determined by the degree-of-interest determining section to be low in degree of interest.

6. The content recommendation apparatus according to claim 1, wherein the recommended content identifying section identifies recommended contents in order from the most recent one among contents retrieved by the content searching section.

7. The content recommendation apparatus according to claim 1, wherein the recommended content identifying section identifies, as the recommended content, a content high in degree of similarity to an acquired document among content retrieved by the content searching section.

8. A content recommendation system in which a server and an information processing apparatus are connected through a network, wherein:
the server comprises:
a first database in which documents are systematized for each category including the documents and for each term included in the documents; and
a second database in which degrees of a user's interest in predetermined terms are systematized, and
the information processing apparatus comprises:
an identification section which identifies a category of a document acquired via the network and/or a term included in the document based on the first database;
a search keyword extracting section which extracts, as a search keyword, a term associated with the category of the document and/or the term identified by the identification section;
a content searching section which searches for a content using the search keyword extracted by the search keyword extracting section;
a classification section which classifies a term included in a document in the content retrieved by the content searching section based on an appearance frequency;
a feature value determining section which determines a feature value of a term in a category of the term classified by the classification section;
a degree-of-interest determining section which determines a degree of interest in each term classified by the classification section based on the second database; and
a recommended content identifying section which identifies, from contents retrieved by the content searching section, a recommended content based on the feature value and/or the degree of interest.

9. A content recommendation method which recommends a content based on a first database, in which documents are systematized for each category including the documents and for each term included in the documents, and a second database in which degrees of a user's interest in predetermined terms are systematized, the method comprising:
causing a computer to identify a category of a document acquired via a network and/or a term included in the document based on the first database;
causing the computer to extract, as a search keyword, a term associated with the category of the document and/or the term identified;
causing the computer to search for a content using the extracted search keyword;
causing the computer to classify a term included in a document in the retrieved content based on an appearance frequency;
causing the computer to determine a feature value of a term in a category of the term classified;
causing the computer to determine a degree of interest in each of the classified terms based on the second database; and
causing the computer to identify a recommended content from the retrieved contents based on the feature value and/or the degree of interest.

10. A program for an information processing apparatus, which recommends a content based on a first database, in which documents are systematized for each category including the documents and for each term included in the documents, and a second database in which degrees of user's interest in predetermined terms are systematized, the program causing a computer to execute:
identifying a category of a document acquired via a network and/or a term included in the document based on the first database;
extracting, as a search keyword, a term associated with the category of the document and/or the term identified;
searching for a content using the extracted search keyword;
classifying a term included in a document in the retrieved content based on an appearance frequency;
determining a feature value of a term in a category of the term classified;
determining a degree of interest in each of the classified terms based on the second database; and
identifying a recommended content from the retrieved contents based on the feature value and/or the degree of interest.
